(19) United States
(12) Patent Application Publication
(10) Pub. No.: US 2007/0079087 A1
(43) Pub. Date: Apr. 5, 2007

(54) User interface for archival storage of data

(75) Inventors: You Wang, Longmont, CO (US); Steven Fredrick Hartung, Boulder, CO (US)

Correspondence Address: Trellis Intellectual Property Law Group, PC, 1900 EMBARCADERO ROAD, SUITE 109, PALO ALTO, CA, 94303, US

(73) Assignee: COPAN Systems, Inc., Longmont, CO (US)

(21) Appl. No.: 11/540,500

(22) Filed: Sep. 28, 2006

Related U.S. Application Data
(60) Provisional application No. 60/722,215, filed on Sep. 29, 2005.
(60) Provisional application No. 60/730,288, filed on Oct. 25, 2005.

(51) Int. Cl. G06F 12/16

(52) U.S. Cl. 711/161

(57) ABSTRACT

A user interface for a secondary storage system, where the secondary “backup” data resides in a power-managed disk array, is provided. The user interface enables a user of the secondary storage system to create and schedule archiving and retrieving tasks for files or directories. The user can manage the users of the secondary storage system. The user can also view details of currently executing tasks. Further, the user interface enables users to search for files and directories in the secondary storage system.

### CROSS REFERENCES TO RELATED APPLICATIONS

This application claims priority to the following applications, hereby incorporated by reference, as if set forth in full in this application:

U.S. Provisional Patent Application Ser. No. 60/730,288, entitled ‘USER INTERFACE FOR ARCHIVAL STORAGE OF DATA’, filed on Oct. 25, 2005 and U.S. Provisional Patent Application Ser. No. 60/722,215, entitled ‘SYSTEM FOR ARCHIVAL STORAGE OF DATA’, filed on Sep. 29, 2005.

### BACKGROUND

Particular embodiments relate in general to computer data storage systems, and more specifically, to a user interface for data storage systems.

It is often critical to make back-up or archival copies of data. Archiving can be useful to free up a primary storage system to accommodate additional data; to enable data to be restored if it is lost, destroyed or corrupted; to improve system efficiency for data that is accessed infrequently, as well as for other reasons.

A typical data storage system uses an array of disk drives as the primary storage. Data from the primary storage is copied or transferred to an archive storage system. The archive system is usually larger, slower and less costly than the primary system, such as tape drives, slower disk drives, optical drives, etc., are used. However, the archive storage system can be designed to cost less per storage unit and consume less power. Care must be taken to create an efficient archive file system so that storage and retrieval between the primary and archive systems does not interfere with the overall operation of a computer system that the archive system is designed to support.

The ability of a system administrator to manage archive tasks, view, organize and restore archived files and directories, and to perform other functions is important for the smooth operation of many types of computer applications. A user interface that enables a system administrator to manage archive tasks and restore archived files or directories is convenient.

### SUMMARY

A method for viewing data units in a secondary storage system is provided, in accordance with various embodiments of the invention. The secondary storage system maintains data units transferred from a primary storage system. Further, the secondary storage system comprises a plurality of secondary storage media, where not all of the plurality of the secondary storage media is in a powered-on mode at the same time. The method includes receiving a request to view data units stored on the secondary storage system. Further, the method includes determining information for data units. The information for the data units includes information for data units stored on a first and second secondary storage media. The second secondary storage medium is at a lower power mode of operation than the first secondary storage medium at the time the information is determined. Furthermore, the method includes providing a view of the data units using the information. The view of the data units shows the information for data units stored on both the first secondary storage medium and the second secondary storage medium.

### BRIEF DESCRIPTION OF THE DRAWINGS

FIG. 1 illustrates a block diagram of an archival system, in accordance with various embodiments.

FIG. 2 illustrates a flow chart depicting a method for viewing data units in a secondary storage system, in accordance with various embodiments.

FIG. 3 shows an exemplary user interface for the archival system, in accordance with various embodiments.

FIG. 4 illustrates a retrieve scheduler, in accordance with various embodiments.

FIG. 5 shows a tasks viewer of the user interface, in accordance with various embodiments.

FIG. 6 illustrates a job monitor of the archival system, in accordance with various embodiments.

FIG. 7 shows the log viewer of the archival system, in accordance with various embodiments.

FIG. 8 illustrates a user interface for searching the data units that are stored in the secondary storage system, in accordance with various embodiments.

### DETAILED DESCRIPTION OF EMBODIMENTS

Embodiments of the present invention provide a method, system and computer program product for a user interface for archival storage of data. The user interface is used for archiving, various files from a primary storage system in a secondary storage system, retrieving various files from the secondary storage system to a primary storage system and managing them. Further, a systems administrator of the user interface for archival storage of data can manage various users of the archival storage system.

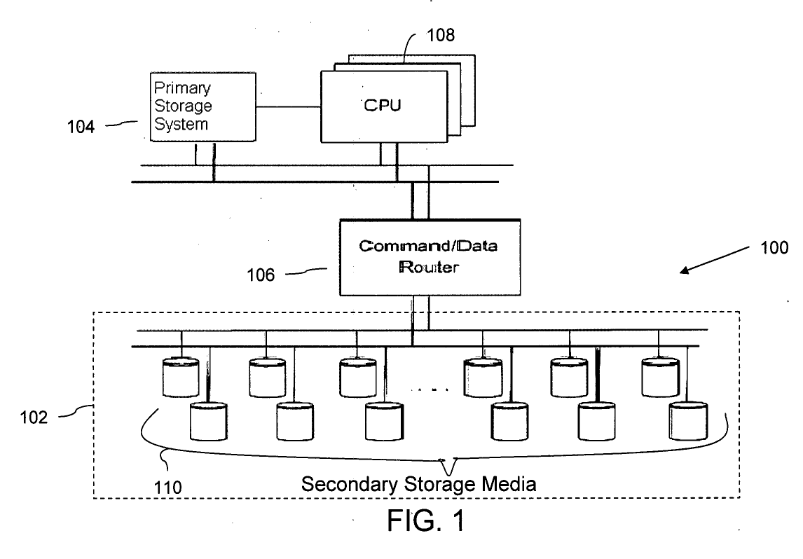

FIG. 1 illustrates a block diagram of an archival system 100, in accordance with various embodiments. Particular embodiments include features for enabling data archiving in computer systems. Archival system 100 includes a secondary storage system 102, a primary storage system 104, a command router 106, and a central processing unit (CPU) 108. Archival system 100 enables a user of the storage system 100 to store data units from the primary storage system 104 in the secondary storage system 102. The data units stored in the secondary storage system 102 may be one or more data units containing information or data. Further, the secondary storage system 102 may include one or more data drives which may be powered-on or on a lowered powered mode of operation at a given moment of time. The data units present in the primary storage system 104 can be archived in the secondary storage system 102. The secondary storage system 102 further includes a plurality of secondary storage media 110. The one or more disk drives in the plurality of the secondary storage media 110 can be in a powered-on mode or in a lower power mode of operation. The one or more disk drives of the plurality of the plurality of secondary storage media 110 containing the data units may be powered-on from a lower power mode of operation when the user of the archival system 100 retrieves the data units from the plurality of secondary storage media 110. In an embodiment, the second secondary storage medium may be in a lowered power mode of operation as compared to the first secondary storage medium. For example, the second secondary storage medium may be spinning at a lower speed or may be idle as compared to the first secondary storage medium. Further, the lower power mode of operation may include a powered off state or standby state. Access to the data units from a secondary storage medium in the lower power mode of operation may be slower than if the second storage medium is powered on.

The user the storage system 100 may view the one or more data units stored on the secondary storage system 102 when the plurality of secondary storage media 110 is in a lower power mode of operation. The CPU 108 of the archival system 100 maintains metadata of the data units that are stored at the secondary storage system 102. The metadata may include one or more attributes pertaining to the data units that are stored in the plurality of secondary storage media 110.

The command router 106 is capable of interpreting the commands given by the user of the storage system 100. Command router 106 is an interface between CPU 108 and secondary storage system 102. The command router 106 is capable of interpreting the one or more commands sent by the user of the archival system 100 through the CPU 108. The command router 106 then carries out various operations on the secondary storage system 102 based on the commands that are provided by the user of the archival system 100. The user of the archival system 100 can direct the command router 106 to perform operations such as archival of data units in the secondary storage system 102, retrieval of data units from the secondary storage system 102 to the primary storage system 104.

The user of the archival system 100 can use a managing system to carry out various operations on the data units stored in the secondary storage system 102. The user of the archival system 100 can carry out different operations, such as archiving data units from the primary storage system 104 into the secondary storage system 102, retrieving data units from the secondary storage system 102, viewing the data units, etc., based on instructions provided by the user.

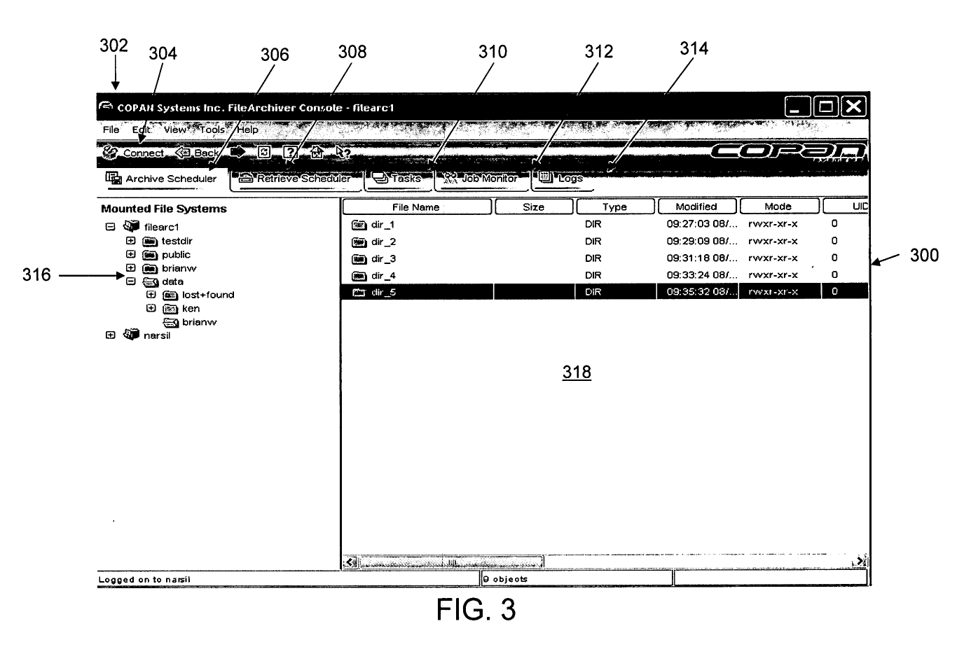

The CPU 108 of the archival system 100 may include a user interface, which helps a user to manage various tasks that need to be carried out at the archival system 100. These tasks may include, but are not limited to, archiving various data units present in the primary storage system 104 into the secondary storage system 102 and retrieving data units that are stored on the secondary storage system 102. Further, the user interface enables the user of the archival system 100 to select data units that need to be archived in the primary storage system 104, schedule an archival task for data units for predefined intervals of time, or schedule a retrieval task for the data units that are stored on the secondary storage system 102, based on the predefined properties of the data units. Further, the user of the archival system 100 may view the data units that are stored on the plurality of secondary storage media 110 even when the one or more disk drives, on which the file or directory is stored, is in a lower power mode of operation. The user interface of the archival system 100 is explained further in conjunction with FIG. 3.

In an embodiment, the user interface for managing the archive system, which may be based on a power managed redundant array of independent/inexpensive disks (RAID) system or a power managed massive array of independent/ inexpensive disks (MAID) system, is provided. In a power managed storage system only a limited number of storage devices are powered on at a time according to a maximum permissible power consumption or “power budget.” Power-managed RAID systems are described in, for example, U.S. Pat. No. 7,035,972, entitled ‘Method and Apparatus for Power Efficient High-Capacity Storage System’, which is incorporated herein by reference, as if set forth in this document in full for all purposes.

Another embodiment provides file-level storage on a MAID platform. The user of the archival system 100 can be a user or a system administrator of the archival system 100. The user interface can be used to archive data units that are stored in the primary storage system 104. The user can also retrieve archived data units from the secondary storage system 102 to the primary storage system 104. Further, the user interface provides a number of additional features that are useful for implementing the file-level storage on a MAID platform.

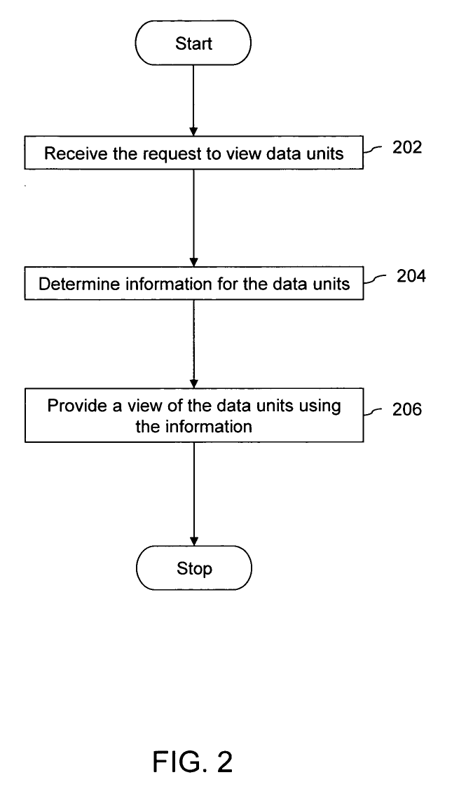

FIG. 2 illustrates a flow chart depicting a method for viewing data units in a secondary storage system 102, in accordance with various embodiments. The user of the storage system 100 can view the one or more data units that are stored in the secondary storage system 102. The data units may be stored on the plurality of secondary storage media 110. The plurality of the secondary storage media 110 includes one or more disk drives that may be powered-on or in a lower power mode of operation at a given time. The CPU 108 of the archival system 100 includes a metadata file that comprises information or data pertaining to the data units that are stored on the plurality of storage media 110. The data or information of the data units may include one or more attributes of the data units such as a file name of the data unit, a file size of the data unit, a created date and/or a modified date of the data unit, the disk drive on which the data unit is stored, etc.

The user of the archival system 100 may wish to view the one or more data units that are stored in the plurality of the storage media 110. Some of the storage media 110 may be in a lower power mode of operation. The archival system 100 can allow viewing of these data units using the metadata stored in the archival system 100. Conventionally, the viewing of data units in secondary storage system 102 that is in a lower power mode of operation may not have been possible. However, using embodiments of the present invention, the metadata may not be stored on the second storage media that is in a lower power mode of operation. Thus, a view of the data units may be provided. Further, the secondary storage media 110 may not have to be powered up to provide the view.

The method of viewing the data units stored in the secondary storage system 102 is explained in the FIG. 2. At step 202, the archival system 100 receives a request to view data units stored on the secondary storage system 102. In an embodiment, of the request is received by the archival system 100 through a user interface of the archival system 100. In an embodiment, the one or more commands may be UNIX based commands.

At step 204, information of data units is determined at the archival system 100. The information may include information pertaining to the data units that are present in a first secondary storage media and a second secondary storage media. The plurality of the secondary storage media 110 includes the first and second storage media. The second secondary media can be in a lower power mode of operation than the first secondary storage media. In one situation, the first secondary storage media can be in a powered-on state and the second secondary storage media can be in a lower power mode of operation at the time when the information is determined about the data units. Also, the second secondary storage media may be in a lower power mode such that access to data unit is slower than if it were in the powered-on state.

At step 206, a view of the information of data units can be provided to the user of the archival system 100. The view can include information for the data units that are stored at the first and the secondary storage media. This allows the user to perform tasks with the data units. For example, the user of the archival system 100 can create an archiving task for the data units that are stored at the primary storage system 104 for archiving the data units to the secondary storage system 102. The secondary storage system 102 can store the data units on a plurality of secondary storage media 110. Further, a portion of the data units can be archived on the second secondary storage media, which is in a lower power mode of operation at the time of the archiving task. The archival system 100 may identify the second secondary storage media that is in the lower power mode of operation and can power-on the second secondary storage media for archiving the data units.

In an embodiment, the user may associate the one or more attributes to the data units that are stored in the first and second secondary storage media. The one or more attributes can be used to identify the data units that are stored in the secondary storage system 102. The one or more attributes can further be used to retrieve the data units from the plurality of secondary storage media 110 to the primary storage system 104. The one or more attributes may include some inherent attributes of the data unit and some user defined attributes. The one or more attributes many include, but are not limited to, a name of the data unit, a size of the data unit, a created data and a modify date of the data unit, a date of archival of the data unit, a location of the disk drive in which the data unit is archived. The user of the archival system 100 may also define the one or more attributes of the data unit for viewing the data units. In an embodiment, the one or more data units may also include versioning information of the data units. Further, the versioning information of the data units can be used to view various versions of the data units that are stored in the secondary storage system 102.

The user of the archival system 100 can also retrieve the one or more data units that are stored in the secondary storage system 102 to the primary storage system 104. The user can do so by creating a retrieving task for the data units stored at the plurality of the secondary storage media. The user can also retrieve the data units that are stored on the second secondary storage medium that is in a lower power mode of operation as compared to the first secondary storage medium that is powered-on. A view of the data units can be provided to the user when the second secondary storage medium is in the lower power mode of operation. At the time of retrieving the data units that are stored on the second secondary storage medium, the second secondary storage medium may be powered-on and the data units may be retrieved onto the primary storage system 104.

In an embodiment of the present invention, the user of the archival system 100 may schedule an archiving or retrieving task for archiving and retrieving the data units. The user can do so by using the user interface of the storage system 100 or by sending commands to the archival system 100. The scheduling of the archiving or retrieving task can be done based on the information or the one or more attributes associated with the data units. Further, the user can specify one or more parameters with the archiving or retrieving task while scheduling the archiving and retrieving task.

In another embodiment, the method of viewing the data units present at the secondary storage system 102 may include a monitoring of an ongoing job. The ongoing job can be a prescheduled or recently created archiving or retrieving task. The user of the archival system 100 is able to view the instance of the archiving or retrieving task using the user interface of the archival system 100. Further, the user of the archival system 100 may send a command to navigate through a portion of the data units that are stored at the plurality of the secondary storage media. Further, information about the data units that are stored on the first and the second secondary storage media can be displayed to the user.

FIG. 3 shows an exemplary user interface 300 for the archival system 100, in accordance with various embodiments. The user interface 300 can be used to view data units in the secondary storage system 102. In FIG. 3, the user interface 300 includes a plurality of tabs and buttons for executing various functions at the secondary storage system 102. User interface 300 includes a file option 302, a connect option 304, an archive scheduler 306, a retrieve scheduler 308, a tasks viewer 310, a job monitor 312, and a log viewer 314. Further, the user interface 300 includes a viewing section configured to provide a view of the data units using information for the data units. The information may pertain to the data units that are stored on the plurality of secondary storage media 110. The plurality of secondary storage media 110 includes the first secondary storage medium that is in a powered-on state and the second secondary storage medium that is in a lower power mode of operation. The user of the archival system 100 can use the user interface 300 for viewing various data units that are stored on the first and the second secondary storage media.

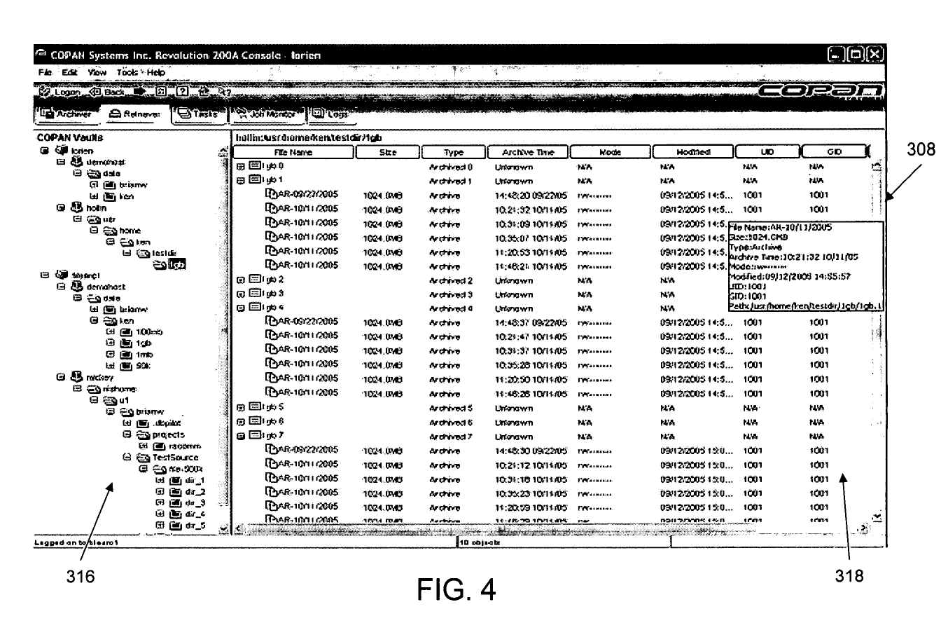

The file option 302 provides the user of the user interface 300 with various operations that can be carried out at the archival system 100. The connect option 304 is used to connect the user to an archival system 100 and to mount a file system on the primary storage system 104. The users of user interface 300 include system managers, system administrators and persons using the storage system 100 to store data units in the archival system 100. The archive scheduler 306 can be used to create an archiving task for the archival system 100. The archive scheduler 306 can also be used to specify predefined archiving of data present at the primary storage system 104 into the secondary storage system 102. The retrieve scheduler 308 can be used to create retrieve tasks for retrieving files or directories from the secondary storage system 102 in the archival system 100. The retrieve scheduler 308 can be used to retrieve the data or information stored in the secondary storage system 102. The retrieve scheduler 308 is explained further in detail in conjunction with FIG. 4.

The tasks viewer 310 can be used to view different archiving and retrieving tasks that are scheduled for the secondary storage system 102. The task viewer 310 can also be used to edit or update one or more scheduled archive or retrieve tasks. The job monitor 312 enables the user to view various archiving and retrieving tasks being executed at the secondary storage system 102. Log viewer 314 lists all the archiving and retrieving tasks that have taken place at the secondary storage system 102.

The viewing section of the user interface 300 includes a directory view 316 and a detail view area 318. The directory view 316 can be used for viewing the secondary storage system 102 and the storage shelves, for example, in a tree like structure. The directory view 316 enables a user of the archival system 100 to navigate through various secondary storage systems 102 of the archival system 100. The detail view area 318 can be used to display various details with respect to the data units, depending on the operation being performed.

FIG. 3 further illustrates the archive scheduler 306 of the user interface 300. The user of the archival system 100 can use the archive scheduler 306 to carry out various archiving tasks that can be performed in the archival system 100. When the archive scheduler 306 of the user interface 300 is selected, information about the mounted data units is displayed at the detail view area 318. The user can navigate through the data units by using either the directory view 316 on the left or by opening the data units in the detail view area 318. Examples of the information that can be displayed at the detail view area 318 when a data unit is selected at the user interface 300 include, but are not limited to, a name of the data unit, a size of the data unit, a type of the data unit, a modify date of the data unit, a mode related to the data unit, a host and a path of the data unit. The type of the data unit can be a directory or a file. In case the type of the data unit is a directory, the data unit may contain one or more files or directories. On the other hand, if the type of the data unit is a file, it may contain information or data. The modify date of the data unit can be the date on which the data unit was last modified. The mode of the data unit can be vital information related to the data unit. For example, the mode of the data unit can specify whether the data unit is read or write enabled or not. The host is the original location where the data units are residing or stored. The path shows the route that should be followed by a user to locate the data unit. A user identification of the user who created the data unit, and the group identification, to which the user belongs, can also be displayed on the detail view area 318. Other similar details related to the archiving tasks can be provided in the detail view area 318. The data unit can be stored at one or the first secondary storage medium or a second secondary storage medium of the plurality of the secondary storage media 110. The first secondary storage medium can be powered-on and the second secondary storage medium can be in a lower power mode of operation at any given time.

A user can create new archiving tasks to archive a first set of data units in the secondary storage system 102 by using the archiving scheduler 306. The first set of data units can include one or more files in a primary storage system 104 and can be located in a single directory. Therefore, the user can select either the entire directory or one or more files for archiving in the secondary storage system 102. If the user of the archival system 100 wants to archive data units from the primary storage system 104 to the second secondary storage medium, then the second secondary storage medium is powered-on from a lower power mode of operation. Further, at the same time one or more of the disk drives of the first secondary storage medium that are not being used currently, may be switched to the lower power mode of operation in order to save power consumption.

The user of the archival system 100 may wish to view the data units present on the first and second secondary storage media. The user can do so even when the second secondary storage medium is powered-off using the metadata that is stored on the first storage media that is powered on.

In an embodiment, the user can create the archiving task by providing details about the new archiving task. Exemplary details that can be used to define a new archiving task include, but are not limited to, the task title, the task description, whether to compute hash, the number of days for retention of the file or directory, and the size of the storage drive and time filters. The user may also specify one or more parameters for identifying the archiving task. In another embodiment, the user can also specify the disk drive of the one or more disk drives in the plurality of the secondary storage media 110 on which he/she wants to archive the data units.

The user of the archival system 100 can further schedule a schedule an archiving task as a recurring archiving task. The user can create a recurring archiving task by selecting the task viewer 310 of the user interface 300. The user can select the recurrence time and the recurrence description of the archiving task. The recurrence time of the archiving task may include, but is not limited to, daily, weekly or monthly. The user can specify the recurrence pattern of the archiving task by selecting the day of the week on which the recurrence should occur. Examples of various recurrence parameters that can be specified by the user may include, but are not limited to, an archiving start date, an archiving start time, an archiving end date, and a number of recurrence instances.

FIG. 4 illustrates the retrieve scheduler 308, in accordance with various embodiments. The retrieve scheduler 308 displays information about the data units that have been archived in the secondary storage system 102. Information about the stored data units can be displayed on the detail view area 318. Examples of the information displayed at the detail view area 318 include, but are not limited to, a name of the data unit, a size of the data unit, the type of the data unit (whether it is a file or a directory), the date and time when the data unit was archived in the secondary storage system 102, the time and date when the data unit was last modified, user identification of the user who created the data unit, and group identification of the group to which the user belongs.

Further, the user can create new retrieving tasks for retrieving the data units that are stored in the secondary storage system 102 by using the retrieve scheduler 308 of the user interface 300, The user can create the task by providing the details of the new retrieving task. Exemplary details that can be used to define a new retrieving task include, but are not limited to, the task title, the task description, and the location to where the archived data unit can be retrieved. To create the new retrieving task, the user of the archival system 100 is presented with various screens on which the details can be provided. A user can retrieve the data unit stored on the first and the second secondary storage media. The user can view the data unit stored on the second secondary storage medium that is in the lower power mode of operation, with the help of the metadata which is stored at the CPU 108 of the archival system 100. Further, when the user tries to retrieve a data unit that is stored at the second secondary storage medium, the second secondary storage medium is powered-on and the data unit is retrieved at the location, specified by the user, in the primary storage system 104.

The user of the archival system 100 can schedule a retrieving task as a recurring retrieving task and create a recurring retrieving task by selecting the task viewer 310. The user can select the retrieve task tab and the retrieving task listed on the detail view area 318. As described before, to create a recurring archiving task, the user can specify the recurrence time for the recurring retrieving task. Further, the user can specify the recurring parameters for the recurring retrieving task. The recurrence time of the retrieving task may include, but is not limited to, daily, weekly or monthly, when the date or the day of the retrieving task can be specified. The user can specify the recurrence pattern of the retrieving task and select the day of the week the recurrence should occur. Examples of various recurrence parameters, which can be specified by the user, may include, but are not limited to, the retrieving start time, the retrieving start date, the retrieving end date, and the number of recurrence instances.

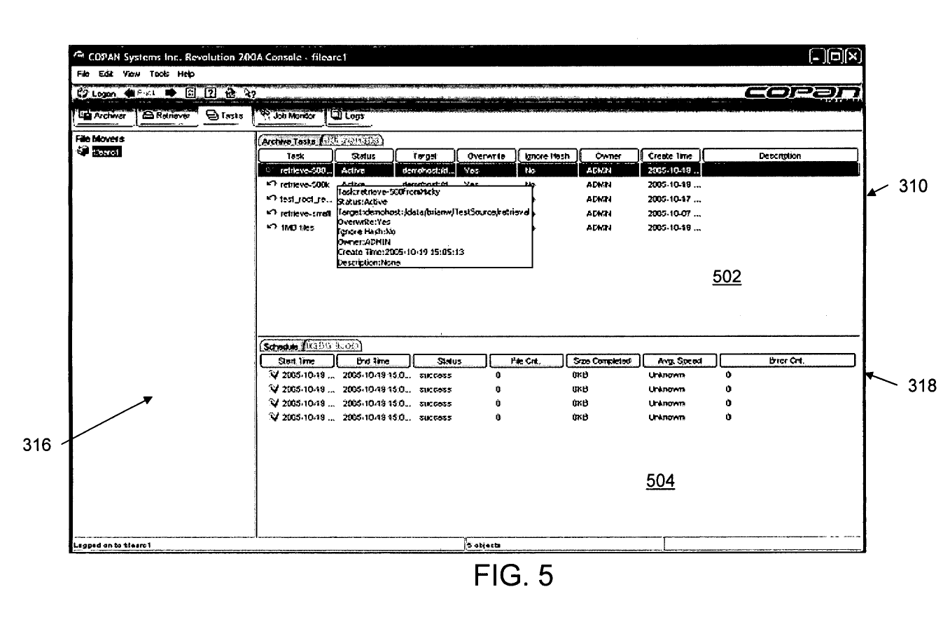

FIG. 5 shows the tasks viewer 310 of user interface 300, in accordance with various embodiments. When the tasks viewer 310 is selected, information related to existing archive and retrieving tasks is displayed in the detail view area 318. The user can browse through various archiving tasks by using the directory view presented in the directory view 316, or by means of the archiving tasks provided in the detail view area 318. For the purpose of this description, the detail view area 318 is divided into two sections, namely, a first section 502 and a second section 504. The first section 502 of the detail view area 318 provides an option whether archive or retrieving tasks are to be shown. The second section 504 of the detail view area 318 provides details of the scheduled tasks. Further information pertaining to recently executed tasks can also be shown in the detail view area 318. A user can select an archiving or retrieving task in the first section 502, and schedule the task by providing the corresponding details in the second section 504 of the detail view area 318.

Information displayed on the detail view area 318, pertaining to archiving tasks, includes, but is not limited to, the name of the task, the status of the task (whether it is active or inactive), number of copies, the time of retention for which the task has been scheduled, a user identification of the user who created the archiving task, the time and date when the archiving task was created, and a short description of the archiving task. When the user chooses to view retrieving tasks in the first section 502 of the detail view area 318, information about the retrieving tasks that have been created is displayed on the detail view area 318. Information displayed on the detail view area 318, when a user chooses to view the retrieving tasks, includes, but is not limited to, the name of the retrieving task, the status of the retrieving task (whether it is active or inactive), the location from which the data units are being retrieved, whether some data units may have been overwritten by the retrieved data units, user identification of the user who created the retrieving task, the time and date when the retrieving task was created, a short description of the retrieving task, etc.

The second section 504 of the detail view area 318 can display information regarding the schedule of the archiving or retrieving task and information regarding an instance of the archiving or retrieving task. The information displayed on the second section 504 of the detail view area 318 includes, but is not limited to, a schedule identification number, whether the task is a single-occurrence or a recurring task, the time and date for which the task is scheduled, the time and date of the last run of the task, the time and date for the next run of the task, the frequency of occurrence of the task, and a short description of the task. The second section 504 can then be used to schedule the existing archiving or retrieving task. Further, the user of the archival system 100 can specify details pertaining to the time and date of the schedules of the archiving or retrieving task by using the schedule tab.

The second section 504 of the detail view area 318 can also display information related to previous instances of execution of all the archiving and retrieving tasks. Examples of such information include, but are not limited to, the start time of the instance of the task, the end time of the instance of the task, the status of the instance of the task (whether it is completed or has been aborted), the number of times the data units have been archived or retrieved, the size of the data unit that was archived or retrieved in the instance of the task, and the errors encountered while archiving or retrieving in the instance of the task. In an embodiment, a user can also activate or deactivate archiving and retrieving tasks with the help of the tasks viewer 210.

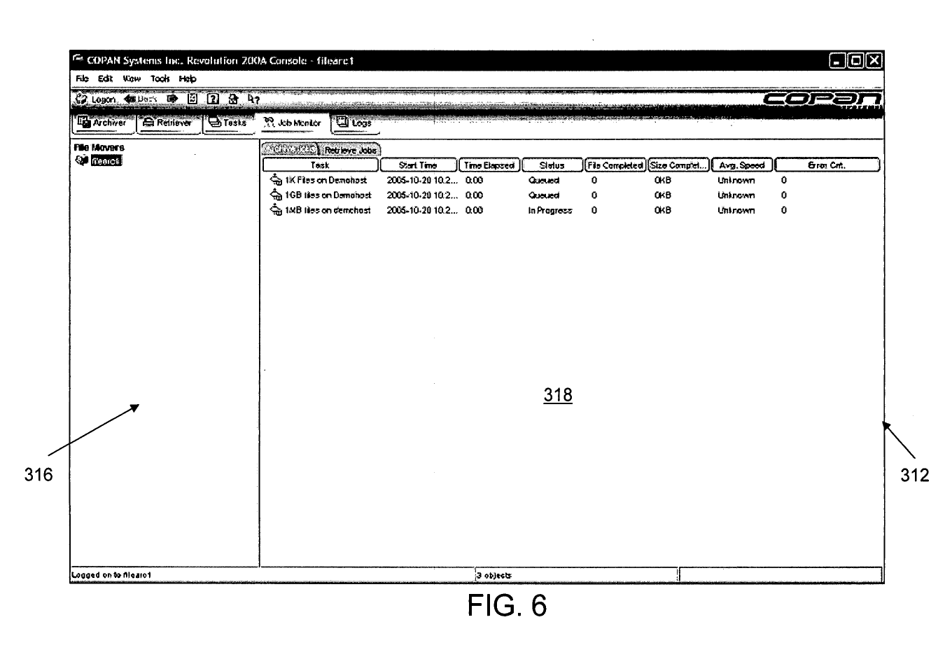

FIG. 6 illustrates the job monitor 312 of the archival system 100, in accordance with various embodiments. When the job monitor 312 is selected in the user interface 300, information pertaining to the ongoing jobs for the secondary storage system 102 is displayed at the detail view area 318. Jobs are individual instances of tasks. Therefore, a task can be considered to be a template, for example, archive media files every Monday, whereas a job can be considered to be an activity, based on the template, for example, media files archived on a particular date, based on the exemplary task mentioned above. The detail view area 318 of the user interface 300 can list information regarding the ongoing archiving and retrieving jobs.

When the ongoing archiving jobs are viewed, the information displayed at the detail view area 318 includes, but is not limited to, the name of the archive tasks that are being performed, the start time and date when the archive task was started, the time elapsed since the archiving job was started, the status of the archiving task (its current progress or if it was aborted), the time when the archiving task is expected to be completed, the size of the data unit that has been archived, and the errors that occurred in the archiving the data units. Similarly, when ongoing retrieving jobs are viewed, the information displayed at the detail view area 318 includes, but is not limited to, the name of the retrieving jobs that are being performed, the start time and date when the retrieve task was started, the time elapsed since the retrieving job was started, the status of the retrieving task (in progress, completed or aborted), the time when the retrieving task will be completed, the size of the data unit that has been retrieved, and the errors that occurred in the retrieving data units. The user can also view information about the ongoing archiving and retrieving jobs which involve the data units that are stored on the second secondary storage medium, which is powered-off at the present time, with the help of the metadata stored at the CPU 108 of the storage system.

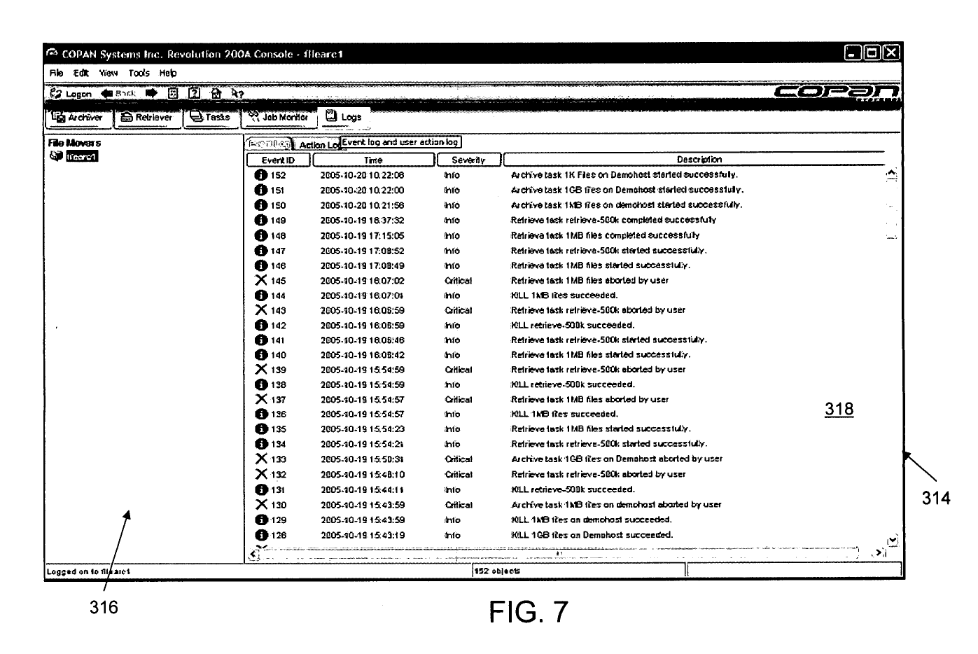

FIG. 7 shows the log viewer 314 of the archival system 100, in accordance with various embodiments. When the log viewer 314 is selected, information pertaining to the archiving and retrieving tasks that have been executed in the past at the secondary storage system 102 is displayed at the detail view area 318. When the log viewer 314 is selected, the detail view area 318 displays a list of events and actions. The events record the execution of a job and the actions any activity performed by the user through the user interface 300. When a user wishes to view the events, the information shown at the detail view area 318 includes, but is not limited to, an event identification number, the time and date when the event occurred, the severity of and a short description of the event. This can be used to detect the occurrence of an error. Similarly, when a user chooses to view actions, the information shown at the detail view area 318 includes, but is not limited to, an action identification number, the user identification of the user who performed the action, the client address from which the action was performed, the time and date and a short description of the action.

In an embodiment, the user of the archival system 100 can manage one or more users of the archival system 100 The user can be provided a user management system which will enable the system administrator of the archival system 100 to manage different users. For example, the system administrator can add a new user, can delete an existing user and can also modify the details of a user. The user or the system administrator of the archival system 100 can register a new user of the system by adding a new user, can modify the details of an existing user and can also delete the profiles of the existing users.

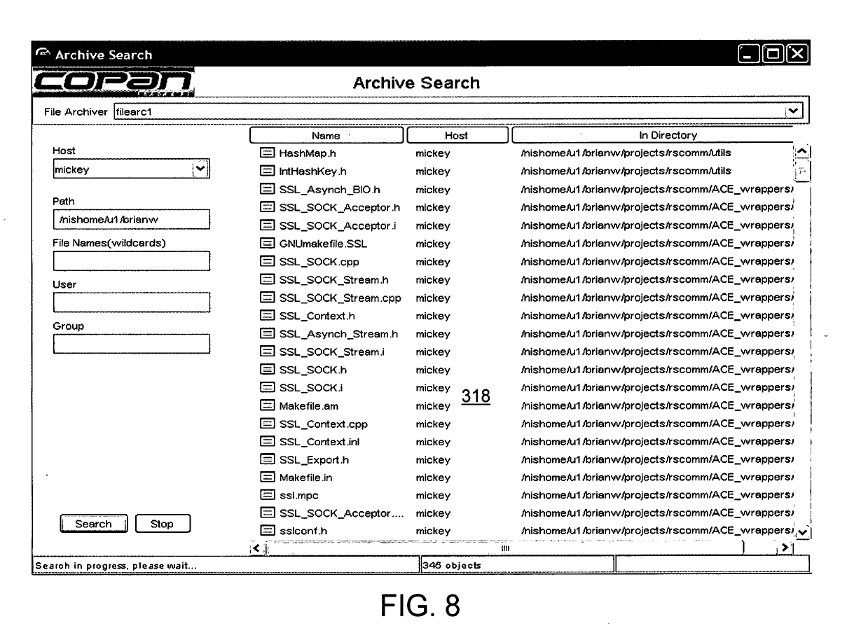

FIG. 8 illustrates a user interface for searching data units that are stored in the secondary storage system 102, in accordance with various embodiments. The data units may be stored at the first secondary storage medium that is powered on at all times and the second secondary storage medium that is in a lower power mode of operation. The user of the archival system 100 can select one or more of the disk drives of the plurality of the secondary storage media 110 in which he/she wishes to search the data units. The data units that are stored on the second storage medium that may be in a lower power mode of operation at a given time can also be viewed by the user of the archival system 100. The second secondary storage medium may be powered-on when the data units are being retrieved. Further, the user can mention one or more parameters to identify the files and directories. These one or more parameters may include, but are not limited to, the host name, the path of the secondary storage drive, the file name, the user name, and the group name to which the user belongs. Multiple combinations of the above-mentioned parameters can also be provided by the user to search the data units. The results of the search can be displayed on the detail view area 318. The details of the data units that can be displayed at detail view are 318 include, but are not limited to, the name of the data units, the host name of the data units, and the path of the location where the data units are stored in the secondary storage system 102.

The user interface 300, as described in particular embodiments or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of particular embodiments. The functions described herein can be achieved in hardware, software, or a combination of both, as desired. Specific programming languages, statements, syntax or other details of the software or software description can be changed as desired.

Although the invention has been described with respect to specific embodiments thereof, these embodiments are descriptive and not restrictive of the invention. For example, it should be apparent that the specific values and ranges of the parameters could vary from those described herein.

Although terms such as ‘data storage device’, ‘disk drive’, etc., are used, any type of storage unit can be adapted for use with the present invention. For example, disk drives, magnetic drives, etc., can also be used. Different present and future storage technologies can be used, such as those created with magnetic, solid-state, optical, bioelectric, nano-engineered or other techniques.

Storage units can be located either internally inside a computer or outside it in a separate housing that is connected to the computer. Storage units, controllers, and other components of systems discussed herein can be included at a single location or separated at different locations. Such components can be interconnected by any suitable means, such as networks, communication links or other technology. Although specific functionality may be discussed as operating at or residing in or with specific places and times, in general, it can be provided at different locations and times. For example, functionality such as data protection steps can be provided at different tiers of a hierarchical controller. Although specific arrangements or storage system designs such as RAID or MAID have been discussed, other embodiments can use any other type of arrangement or configuration. For example, some features may work with standalone computer systems, some independently accessed drives, or even a single drive that may have separate partitions or other data-grouping organizations.

Note that any type of user input device can be used to convey signals to a processor executing the functions of the user interface. For example, a mouse and pointer, trackball, touch screen, digitizing tablet, etc., can all be used. Dedicated controls, such as on a portable computing device, cell phone, e.g., numeric keypad, remote control, etc., can all be used as input devices. Moreover, any manner of indicators or on-screen controls, such as buttons, radio buttons, sliders, windows, dials, menus, etc., can be used. Different organizations and layouts of information can also be used, as desired.

In the description herein, numerous specific details are provided, such as examples of components and/or methods, to provide a thorough understanding of the embodiments. One skilled in the relevant art will recognize, however, that an embodiment of the invention can be practiced without one or more of the specific details; or with other apparatuses, systems, assemblies, methods, components, materials, parts, and/or the like. In other instances, well-known structures, materials or operations are not specifically shown or described in detail, to avoid obscuring aspects of the embodiments of the present invention.

Reference throughout this specification to ‘one embodiment’, ‘an embodiment’, or ‘a specific embodiment’ means that a particular feature, structure or characteristic, described in connection with the embodiment is included in at least one embodiment and not necessarily in all the embodiments. Therefore, the use of these phrases in various places throughout the specification does not imply that they necessarily refer to the same embodiment. Further, the particular features, structures or characteristics of any specific embodiment of the present invention may be combined in any suitable manner with one or more other embodiments. It is to be understood that other variations and modifications of the embodiments of the present invention, described and illustrated herein, are possible in light of the teachings herein, and are to be considered as part of the spirit and scope of the present invention.

It will also be appreciated that one or more of the elements depicted in the drawings/figures can also be implemented in a more separated or integrated manner, or even removed or rendered inoperable in certain cases, as is required, in accordance with a particular application. It is also within the spirit and scope of the present invention to implement a program or code that can be stored in a machine-readable medium, to permit a computer to perform any of the methods described above.

As used in the description herein and throughout the claims that follow, ‘a’, ‘an’, and ‘the’ includes plural references unless the context clearly dictates otherwise. In addition, as used in the description herein and throughout the claims that follow, the meaning of ‘in’ includes ‘in’ and ‘on’, unless the context clearly dictates otherwise.

The foregoing description of the illustrated embodiments, including what is described in the Abstract, is not intended to be exhaustive or limit the invention to the precise forms disclosed herein. While specific embodiments and examples of the invention are described herein for illustrative purposes only, various equivalent modifications are possible within the spirit and scope of the present invention, as those skilled in the relevant art will recognize and appreciate. As indicated, these modifications may be made to the present invention, in light of the foregoing description of the illustrated embodiments, and are to be included within the spirit and scope of the present invention.

Therefore, while the present invention has been described herein with reference to the particular embodiments thereof, latitude of modification, various changes and substitutions are intended in the foregoing disclosures. It will be appreciated that in some instances, some features of the embodiments of the invention will be employed without the corresponding use of the other features, without departing from the scope and spirit of the invention, as set forth. Therefore, many modifications may be made, to adapt a particular situation or material to the essential scope and spirit of the present invention. It is intended that the invention is not limited to the particular terms used in the following claims and/or to the particular embodiment disclosed as the best mode contemplated for implementing the invention, which may include any and all the embodiments and equivalents falling within the scope of the appended claims.

We claim:

1. A method for viewing data units in a secondary storage system, the secondary storage system maintaining data units transferred from a primary storage system, wherein the secondary storage system comprises a plurality of secondary storage media, wherein not all of the plurality of the secondary storage media is in a powered-on mode at the same time, the method comprising:
receiving a request to view data units stored on the secondary storage system;
determining information for the data units, wherein the information includes information for data units on first and second secondary storage media, wherein the second secondary storage medium is at a lower power mode of operation than the first secondary storage medium at the time the information is determined; and
providing a view of the data units using the information, wherein the view shows the information for data units on both the first secondary storage medium and the second secondary storage medium.

2. The method of claim 1, further comprising receiving an archive task for one or more data units in the primary storage system.

3. The method of claim 2, wherein a portion of the one or more data units are in the secondary storage medium that is at the lower power mode of operation at a time of receiving the archive task.

4. The method of claim 1, further comprising:
receiving one or more attributes for the one or more data units; and
associating the one or more attributes with the one or more data units, wherein the one or more attributes allow retrieval of the one or more data units by referencing the one or more attributes.

5. The method of claim 4, wherein the one or more attributes comprise user defined data, the user defined data used in the retrieval of the one or more data units.

6. The method of claim 1, wherein the information comprises user defined data, wherein providing the view using the user defined data to provide the view.

7. The method of claim 1, wherein the information comprises versioning information, wherein providing the view using the versioning information to provide the view showing versions of data units.

8. The method of claim 1, further comprising receiving a retrieval task for retrieving one or more data units in the secondary storage system.

9. The method of claim 5, wherein a portion of the one or more data units are in secondary storage medium that is at the lower power mode of operation at a time of receiving the retrieval task.

10. The method of claim 1, further comprising
receiving a scheduling task for retrieving or archiving one or more data units; and
scheduling the task based on the information for the one or more data units.

11. The method of claim 1, further comprising receiving a monitoring job for an ongoing job, the ongoing job based on an archive task or a retrieval task.

12. The method of claim 1, further comprising:
receiving a command to navigate through a portion of the data units provided in the view; and
displaying information for the data units based on the command.

13. An interface viewing data units in a secondary storage system, the secondary storage system maintaining data units transferred from a primary storage system, wherein the secondary storage system comprises a plurality of secondary storage media, wherein not all of the plurality of the secondary storage media is powered on at the same time, the user interface comprising:
a viewing section configured to provide a view of the data units using information for the data units, wherein the information is for data units on secondary storage media that is not powered on at the time the information is determined, wherein the view shows information for data units on first and second secondary storage media, wherein the second secondary storage medium is at a lower power mode of operation than the first secondary storage medium at the time the information is determined.

14. The interface of claim 13, further comprising:
a tasks viewer configured to display information about one or more archive tasks for data units on the second secondary storage medium that is at the lower power mode of operation.

15. The interface of claim 14 wherein the tasks viewer further comprises a second section for scheduling an archive task selected from the one or more archive tasks.

16. The interface of claim 13, further comprising:
a retrieve scheduler viewer configured to all creation of one or more retrieving tasks for retrieving one or more data units on the second secondary storage medium that is at the lower power mode of operation.

17. The interface of claim 16, wherein the retrieve scheduler viewer further comprises a second section for scheduling a retrieving task selected from the one or more archive tasks.

18. The interface of claim 13, further comprising:
a job monitor for monitoring an ongoing job.

19. The interface of claim 13, further comprising a directory view for navigating through directories in the secondary storage system, wherein a portion of the directories are included on the second secondary storage medium that is at the lower power mode of operation.

20. The interface of claim 19, wherein the view is provided using user defined data specified by a user for the one or more data units.

21. The interface of claim 13, wherein the view is provided using versioning information, wherein the versioning information shows versions of data units.
